(19) United States
(12) Patent Application Publication
(10) Pub. No.: US 2006/0129673 A1
(43) Pub. Date: Jun. 15, 2006

(54) Method and system for providing entity status information in a communication network

(75) Inventors: Ishita Majumdar, Lake Zurich, IL (US); Anurag Das, Palatine, IL (US); Venkat Gopikanth, Buffalo Grove, IL (US); Thomas B. Hart, West Dundee, IL (US); Peter A. Lin, Lisle, IL (US); Valentin Oprescu-Surcobe, Northbrook, IL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 11/000,695

(22) Filed: Dec. 1, 2004

(51) Int. Cl. G06F 15/173

(52) U.S. Cl. 709/224

(57) ABSTRACT

A presence agent (101) receives a message with a request for a status of one or more entities. The presence agent (101) determines the status of the entities, and transmits a message with the status of the entities. Transmitting the message includes initiating a connection to a communication device (107). A watcher (103) monitors the status of the entities, and provides updated information regarding the status to the users. The watcher (103) receives a request for a status of entities, determines the status of the entities, and transmits, in response to receipt of the request, a response indicating the status. A communication device (107) transmits a message having a request for status of entities. The communication device receives, from a connection initiated by a communication network (105), a message with a status of the entities, and processes the status of the entities, in response thereto.

### FIELD OF THE INVENTION

The present invention relates in general to wireless communication units and wireless networks, and more specifically to providing entity status information to a subscriber in a communication network.

### BACKGROUND OF THE INVENTION

In today's connected society, it can be desirable for a user to obtain information regarding a current status of another user, such as whether the other user is presently connected to a communication network. Certain networks can be provided with a capability to collect a variety of information regarding the status of a subscriber. However, the problem of initially providing the status information and then disseminating status information is multifold.

Unfortunately, a solution utilizing methods such as session initiation protocol (“SIP”) is inefficient on a medium of constrained bandwidth, such as in connection with a cellular telephone communication network.

Considering the SIP method as exemplifying conventional solutions, SIP messages tend to be data intensive. For example, currently a presence solution utilizing SIP involves eight messages per presence session. Each SIP message tends to take about 200-250 bytes, and each message conventionally is transmitted across constrained radio frequency resources. The result can be a delay, which may not be desirable to the end user.

Hence, the utilization of SIP and similar implementations or protocols to distribute information regarding the status (such as a presence) of other users tends to add delay and congest the network. Moreover, the real time status information is more likely to be inefficiently distributed due to the additional lag time occasioned in connection with the use of SIP sessions. In addition, utilizing SIP can be expensive for operators to implement, and ultimately can be expensive for subscribers to support.

A conventional alternative suggests that a communication device can initiate a data call periodically (e.g., every 3.5 minutes) and transmit its current status information to the communication network. This also can be expensive, typically for the subscriber who is consuming valuable air time for transmitting status information, even if the status has not changed. An automated periodic update such as the foregoing can result in redundant and unnecessary transmissions of status information.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a diagram illustrating a simplified and representative environment associated with a communication unit and exemplary wireless networks in accordance with various exemplary embodiments for providing entity status information;

FIG. 2 is a diagram illustrating portions of an exemplary infrastructure device arranged for use as a presence agent in accordance with various exemplary embodiments;

FIG. 3 is a block diagram illustrating portions of an exemplary communication unit in accordance with various exemplary embodiments;

FIG. 4 is a block diagram illustrating portions of an exemplary infrastructure device arranged for use in connection with a watcher in accordance with various exemplary embodiments;

FIG. 5 is a flow diagram illustrating an exemplary communication flow in accordance with various embodiments;

FIG. 6 is a flow chart illustrating an exemplary procedure for monitoring an entity list of a subscriber in accordance with various exemplary embodiments;

FIG. 7 is a flow chart illustrating an exemplary procedure for monitoring a status of entities on an entity list in accordance with various embodiments; and

FIG. 8 is a flow chart illustrating an exemplary procedure for monitoring a status of entities on the entity list of a particular subscriber, in accordance with various embodiments.

### DETAILED DESCRIPTION

In overview, the present disclosure concerns wireless communications devices or units, often referred to as communication units, such as cellular phone or two-way radios and the like having an operating capability to provide a status of other subscribers on the network, and the supporting network infrastructure, associated with a communication system such as an Enterprise Network, a cellular Radio Access Network, or the like. Such communication systems may further provide services such as voice and data communications services. More particularly, various inventive concepts and principles are embodied in systems, communication units, and methods therein for providing, to a communication unit, entity status information associated with entities on the communication system.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

The term entity is used herein to broadly refer to a subscriber unit, a communication unit, or other device that, in accordance with one or more embodiments, can be ordinarily associated with a subscriber or other person, even if such person is unknown.

An entity list is utilized to refer to a list of entities, for example, a list of subscribers, where the list corresponds to a particular user, thereby providing the user with a list of, e.g., preferred contacts and optionally associated information. In some embodiments, an entity list can comprise what is commonly referred to as a “buddy list.” In accordance with one or more embodiments, a particular user can have one or more entity lists. Hence, an entity list that is known to the communication network can include a unique identifier to indicate the list and can include, refer to, or correspond to the particular user.

The term status is utilized herein to broadly refer to information that can be collected by the network regarding a presence of an entity in relation to a communication network of interest. Typically, the information that is collected is presented by the entity to the communication network. A change in the status typically is initiated by the entity. In some embodiments, status can include what may be referred to as “presence information”.

As further discussed herein below, various inventive principles and combinations thereof are advantageously employed to provide entity status information with improved efficiency, and reduced expense. Further in accordance with exemplary embodiments, there can be provided a method and system including a watcher that can monitor the status of entities listed in the entity lists of one or more users and that can also provide updated information regarding the status to the users. Status information can be collected, for example, as is conventionally available from a visitor location register (“VLR”) or home location register (HLR). The VLR and/or HLR may be included or cached in a soft switch, a dispatch user database, or the like. The soft switch or dispatch user database are often included or cached in an infrastructure device such as a network controller of a communication network and utilized in connection with, e.g., a mobile switching center. The database, e.g. the VLR and or HLR maintains information on, for example, telephone calls. Conventionally in many systems, the VLR includes information that may be in the HLR. The VLR and/or HLR have information including, whether the user is busy. Current conventions provide that the VLR and/or HLR are updated by the subscriber unit itself, and can include status information of users registered on the infrastructure device.

Accordingly, the watcher can be provided to monitor the status information that is collected, e.g., by the VLR AND/OR HLR, and to provide changed information in accordance with requests therefore to a subscriber. According to one or more embodiments, it can be possible to collect status information without necessarily requiring the communication unit to contact the communication network in order to provide current status information. Further details and examples are provided below.

Referring now to FIG. 1, a diagram illustrating a simplified and representative environment associated with a communication device and exemplary wireless network in accordance with various exemplary embodiments for providing entity status information will be discussed and described. In the representative example, a network 105 provides a communication infrastructure for communication devices including a communication device of subscriber A 107, a communication device of subscriber B 109, and a communication device of subscriber C 111.

Consider, for example, that subscriber A desires to have a buddy list showing the status information of particular buddies. Subscriber A can create a list of entities, e.g., a buddy list, in accordance with known techniques, such as by interacting with the communication device of subscriber A 107. In this example, the entity list of subscriber A includes entities corresponding to subscriber B and subscriber C, as well as possibly other subscribers. In addition, subscriber A may have other entity lists, e.g., a “yoga class” buddy list and a “book club” buddy list. When subscriber A activates the entity list, the communication device of subscriber A 107 can initiate a first communication with a communication network, here represented by the network 105, and can provide the network with the entity list and a request to monitor the entity list. The network 105 (as described in detail below) can provide a current status of the entities on the list to the communication devices of subscriber A 107, for example, that subscriber B and subscriber C are “on”, e.g. registered with the network. The first communication with the network 105 can be terminated. The network 105, more specifically in connection with a presence agent 101 and a watcher 103, can monitor the status of the entities in the entity list. When a status changes, or on a periodic basis, the network 105 can transmit status information corresponding to entities in the entity list to the communication device of subscriber A 107. For example, if the communication device of subscriber B is turned off, the network 105 can transmit an updated status with that information to the communication device of subscriber A 107. The communication device of subscriber A 107 can process the updated status information and provide the information to the subscriber, such as by updating a display on the communication device 107.

The status information that can be provided to the communication devices of subscribers can include status information that is collected by the network 105 from subscriber devices that reflects a presence of the entity in relation to the network 105. Such information could include, by way of example, “on”, “off”, “busy”, “idle”, “available” and/or a location of the subscriber device. Status information can be collected on a variety of devices, including those that lack a data capability as well as more sophisticated devices.

An entity in the entity list can include a user identifier that corresponds to an indicator utilized by the communication network, particularly if the indicator is utilized in connection with collecting status information. For example, the entity in the entity list can specify, e.g., a telephone number, a subscriber identifier, or a dispatch network identifier. User identifiers can be included in entity lists in accordance with known techniques. Moreover, the subscriber that owns a list can themselves be indicated by a user identifier.

The presence agent 101 can be configured to transmit and/or receive communications. The presence agent 101 can utilize information collected regarding status of entities in order to provide status information to the various communication devices. For example, the presence agent 101 can utilize information that is collected by or in a mobile switching center and/or a visitor location register (VLR) and/or a home location register (HLR).

The presence agent 101 can receive a message from the communication device of subscriber A 107 including a request for a status of entities, which can be, for example, provided in an entity list. The message can further specify a request to monitor the status, e.g., of the entities. Optionally, the message can include an indication of the entity list, e.g., an identifier of the entity list and/or identifiers of the entities, and a user identifier corresponding to an owner of the entity list. The presence agent 101 can determine the status of the entity and can initiate a transmission, e.g., via an appropriate downlink, to the communication device of subscriber A 107, where the transmission includes the status of the entities. Also, the presence agent 101 can determine whether there is a change in the status of the entities, and can initiate a transmission to the communication device of subscriber A 107 when there is a change in the status of one or more entities. The transmission which is initiated by the communication network 105 can include, for example, a short messaging service (“SMS”) message. More details are provided below with respect to the presence agent 101.

The communication device, e.g., the communication device of subscriber A 107 can be configured to provide support for one or more embodiments. For example, the communication device of subscriber A 107 can transmit a message, in accordance with known techniques, having a request for a status of one or more entities, e.g., entities in an entity list. Entities and entity lists have been previously described. Such a request can be transmitted, for example, when the communication device is powered on, or if a request is specifically invoked, or if the entities listed in the entity list are changed. In addition, the communication device can receive, from a connection initiated by the communication network 105, a message with a status of the one or more entities that were previously specified. By way of example, a connection initiated by the communication network 105 can include a downlink, e.g., a short messaging service (“SMS”) message. When the communication device receives the status, it can process the status. For example, the status can be provided to update a display on the communication device to indicate a current status of the entities. Other uses of updated status are possible, for example, the communication device can be programmed to automatically perform certain actions based on a particular pre-defined status of a particular entity. Hence, the communication device of subscriber A can be programmed to automatically issue an alarm whenever a status of an entity known as “Mom” becomes “on”. Further details regarding the communication unit are provided below.

The presence agent 101 can communicate with the watcher 103 in order to monitor a status of entities. The watcher 103 can advantageously be included in or co-located with one or more existing soft switches or other network controller functions included in the network infrastructure. The soft switch conventionally includes an internet protocol link that can advantageously be utilized in order to communicate between the watcher 103 and the presence agent 101. Conventionally, status information of any subscriber in the network is updated in a database conveniently located in the soft switch, for example, the VLR and/or HLR.

The watcher 103 can receive a request for a status of one or more entities, e.g., a request with a user identifier, optionally specifying an entity list. The watcher 103 can determine one or more entities corresponding to the user identifier; can determine the status of the entities; and can transmit, in response to the request, a response indicating the status of the one or more entities. Additional detail is provided below with respect to the watcher 103.

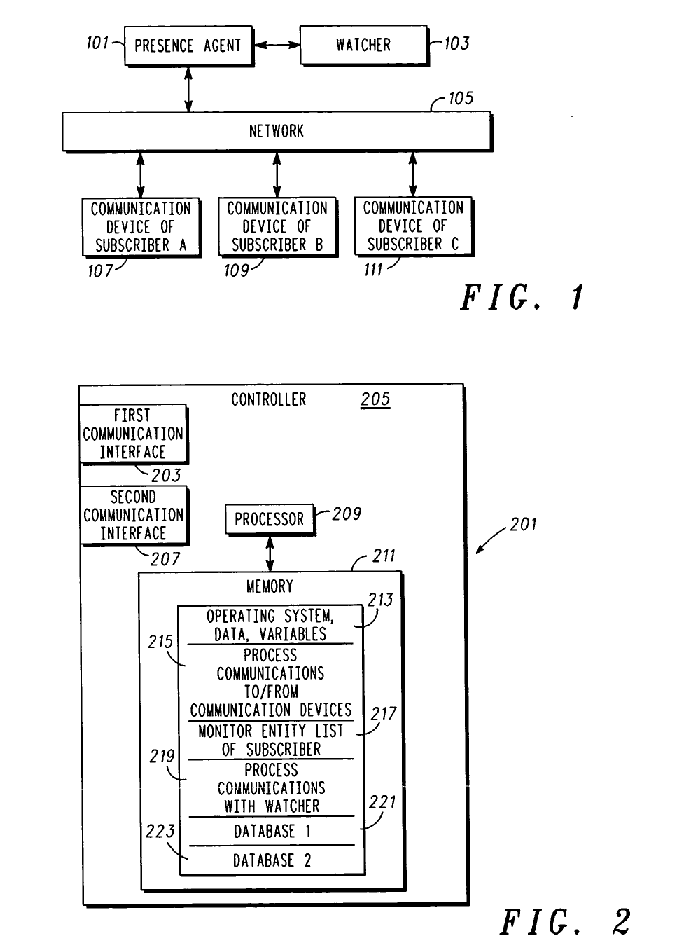

Referring now to FIG. 2, a diagram illustrating portions of an exemplary infrastructure device arranged for use as a presence agent in accordance with various exemplary embodiments will be discussed and described. FIG. 2 is a diagram illustrating an exemplary network controller 201 implementing the presence agent in an exemplary communication network, e.g., a radio access network arranged for providing entity status in accordance with various exemplary embodiments. The network controller 201 may include a first communication port or interface 203 for communicating over first communication network, one or more controllers 205, and a second communication port or interface 207 for communicating over a second communication network. The controller 205 as depicted generally comprises a processor 209, a memory 211, and may include various other functionality that is not relevant but will be appreciated by those of ordinary skill.

The processor 209 may comprise one or more microprocessors and/or one or more digital signal processors. The memory 211 may be coupled to the processor 209 and may comprise one or more of a read-only memory (ROM), a random-access memory (RAM), a programmable ROM (PROM), an electrically erasable read-only memory (EEPROM) and/or magnetic or optical memory or the like. The memory 211 may include multiple memory locations for storing, inter alia, an operating system, data and variables 213 for programs executed by the processor 209; computer programs for causing the processor to operate in connection with various functions such as processing communications to/from communication devices 215, monitoring entity list(s) of various subscribers 217, processing communications with the watcher 219, and/or other processing; a database 221 of various parameters utilizing in monitoring status of entities; and a database 223 for other information used by the processor 209. The computer programs may be stored, for example, in ROM, PROM, etc. and can direct the processor 209 in controlling the operation of the communication controller.

Responsive to signaling received from the first communication port or interface 203, the second communication port or interface 207, or in accordance with instructions stored in memory 211, the processor 209 may handle communications, for example, a request for a status of one or more entities, e.g., in a list of entities. In accordance with one or more embodiments, the request can specifically direct the processor 209 to monitor the status of the entity or entities.

The processor 209 may be programmed to provide functions including, for example, transmitting and receiving communications from a first communication interface 203 over a first communication network, e.g., to communicate with a communication device. Further, the processor 209 can be programmed to provide functions including transmitting and receiving communication from a second communication interface 207 over a second communication network, e.g., to communicate with a watcher. One or more embodiments provide that the processor 209 is programmed to operate in accordance with internet protocol (IP) standards, for example where the watcher has been implemented with a communication interface utilizing IP.

Advantageously, the processor 209 can initiate a connection to the subscriber, for example to transmit the status of one or more entities. This can utilize more efficient communication protocols, can save transmission time, and/or can be performed on an as-needed basis. One appropriate protocol that can be utilized by the processor 209 to initiate a connection to the subscriber is the short messaging service (“SMS”) protocol, although other protocols may be utilized.

The processor 209 can provide for, e.g., determining a status of entities. Status advantageously can be monitored and a change of status can be provided, for example, by the watcher, as explained herein. Determining a status accordingly can include receiving a message from the watcher, where the message includes, e.g., the status of the entity that has changed. Similarly, a request for the status of the entity or entities can be transmitted over the second communication interface 207, e.g., to the watcher.

Further, the processor 209 can be programmed to provide for a change of the entities that are to be included in the entity list. For example, a request can be received from the first communication interface 203 indicating a change of entities in an entity list, e.g., for a particular subscriber. In accordance with alternative embodiments, an entity list can be particularized, in order to support multiple entity lists per subscriber.

One or more embodiments provide that the processor 209 is programmed to provide for transmitting a message indicating a change in the status of one or more entities in the entity list. Such a message can be transmitted, for example, in response to a determination that the status of the entity has changed. Determining a change in status can include receiving a message from the watcher, where the message includes, e.g., the status of the entity that has changed. Similarly, a periodic request for the status of the entity or entities can be transmitted over the second communication interface 207, e.g., to the watcher, and a comparison of prior and current status can be made to determine if the status has changed.

FIG. 3 is a block diagram illustrating portions of an exemplary communication unit in accordance with various exemplary embodiments. The communication device 301 may include a controller 305, a transceiver 303, and a communication port 311 for communication with an external device 309. The controller as depicted generally includes a processor 319, and a memory 321, and may include other functionality not illustrated for the sake of simplicity. The communication unit may further include, e.g., a speaker 313, a microphone 315, a text and/or image display 307, an alerting device (not illustrated) for providing vibratory alert, visual alert, or other alert, and/or a user input device such as a keypad 317.

The processor 319 may comprise one or more microprocessors and/or one or more digital signal processors. The memory 321 may be coupled to the processor 319 and may comprise a read-only memory (ROM), a random-access memory (RAM), a programmable ROM (PROM), and/or an electrically erasable read-only memory (EEPROM) and the like. The memory 321 may include multiple memory locations for storing, among others, an operating system, data and variables 323 for programs executed by the processor 319; computer programs for causing the processor to operate in connection with various functions such as entity list transmission 325, entity list message reception 327, and entity list status processing 329, and/or other processing (not illustrated); a database 331 of various entity lists; and a database 333 for other information used by the processor 319. The computer programs may be stored, for example, in ROM, PROM, or the like and may direct the processor 319 in controlling the operation of the communication device 301.

The processor 319 may be programmed to transmit (cooperatively with the transceiver 303 as is understood) a first message with a request for a status of one or more entities. Optionally, the request can include a list of entities for which status is requested, or an indicator corresponding to the list of entities. Further, the processor 319 can be programmed to receive (cooperatively with the transceiver 303 as is understood), from a connection initiated by the communicate network, a second message having a status of the one or more entities. In addition, the processor 319 can be programmed to process, in response to the second message, the status of the one or more entities.

The display 307 may present information to the user by way of a conventional liquid crystal display (LCD) or other visual display, and/or by way of a conventional audible device (e.g., the speaker 313) for playing out audible messages. The user may invoke functions accessible through the user input device 317. The user input device 317 may comprise one or more of various known input devices, such as a keypad as illustrated, a computer mouse, a touchpad, a touch screen, a trackball, and/or a keyboard. Responsive to signaling from the user input device 317, or in accordance with instructions stored in memory 321, the processor 319 may process stored information or received information. For example, in response to receipt of the second message, the processor 319 can update the display 307 to indicate the status of one or more entities. As another example, the processor 319 can be programmed or otherwise configured to, e.g., interact with the user, in order to determine one or more entities to be included on a particular entity list. Moreover, when one or more entity lists are determined, the processor 319 can transmit one or more entity lists via the transceiver 303. Similarly, when one or more entities are changed in an entity list, the processor 319 can transmit the modified entity list.

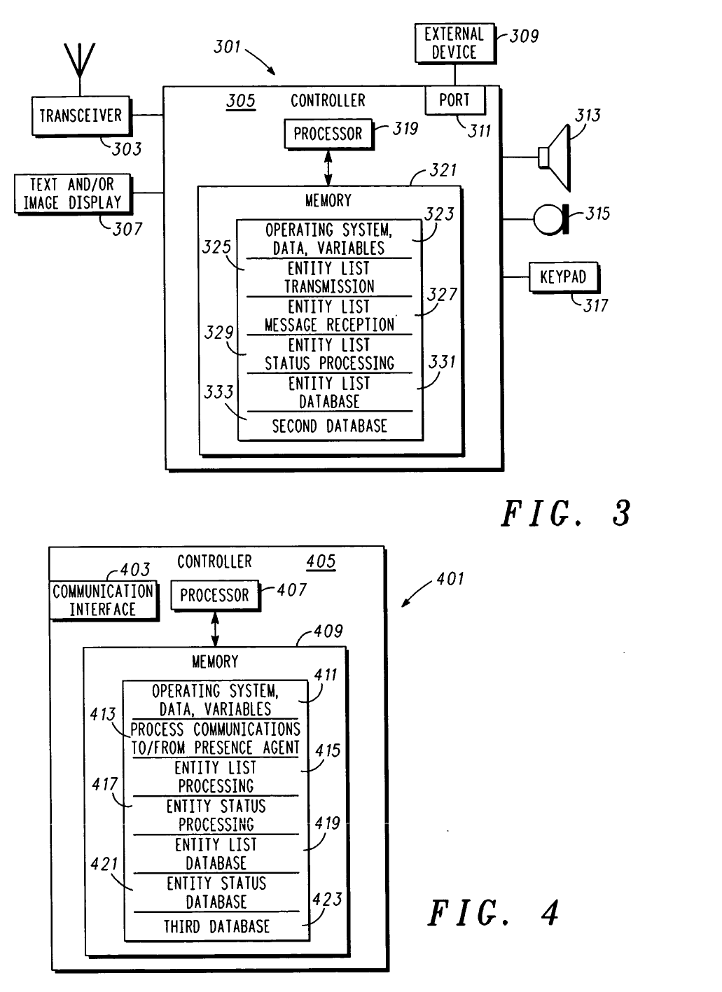

Referring now to FIG. 4, a block diagram illustrating portions of an exemplary infrastructure device arranged for use as a watcher in accordance with various exemplary embodiments will be discussed and described. FIG. 4 is a diagram illustrating an exemplary network controller 401 implementing the watcher, forms a portion of an infrastructure device in an exemplary communication network, e.g., a soft switch, in accordance with various exemplary embodiments. The network controller 401 may include one or more controllers 405, and a communication interface 403. The controller 405 as depicted generally comprises a processor 407, a memory 409, and may include various other functionality that is not relevant but will be appreciated by those of ordinary skill.

The processor 407 may comprise one or more microprocessors and/or one or more digital signal processors. The memory 409 may be coupled to the processor 407 and may comprise one or more of a read-only memory (ROM), a random-access memory (RAM), a programmable ROM (PROM), an electrically erasable read-only memory (EEPROM) and/or magnetic memory or the like. The memory 409 may include multiple memory locations for storing, among others, an operating system, data and variables 411 for programs executed by the processor 407; computer programs for causing the processor to operate in connection with various functions such as processing communications to/from the presence agent, processing entity lists 415, and processing entity status 417, and/or other processing (not illustrated); a database 419 of entity lists; a database of entity status 421; and a third database 423 for other information used by the processor 407. The computer programs may be stored, for example, in ROM, PROM, etc. and can direct the processor 407 in controlling the operation of the controller 405.

Responsive to signaling received from the communication interface 403, or in accordance with instructions stored in memory 409, the processor 407 can handle communications, for example, communications to/from the presence agent.

The processor 407 can be programmed, for example, to receive a request over the communication interface 403 indicating, e.g., a user identifier, where the request is for a status of one or more entities. Advantageously, the communication interface can function in accordance with internet protocol (“IP”) standards. Also, the processor 407 can be programmed to determine one or more entities indicated by the user identifier. Further, the processor 407 can determine the status of the one or more entities, as described further herein. In response to the request, the processor 407 can transmit over the communication interface 403 a response indicating the status of the one or more entities.

One or more embodiments provide that a particular subscriber can have multiple entity lists. Consequently, the request can indicate a list identifier. The processor 407 can retrieve a list of entities that correspond to the user identifier and the list identifier. The entities that are determined by the processor are the entities on the list that has been so particularized.

The processor 407 can be utilized to detect changes of status in specified entities and to inform other processes of the change. For example, the processor 407 can be programmed to facilitate detecting a change of status. In response to detecting such a change, the processor 407 can transmit a message indicating the one or more entities and the corresponding status.

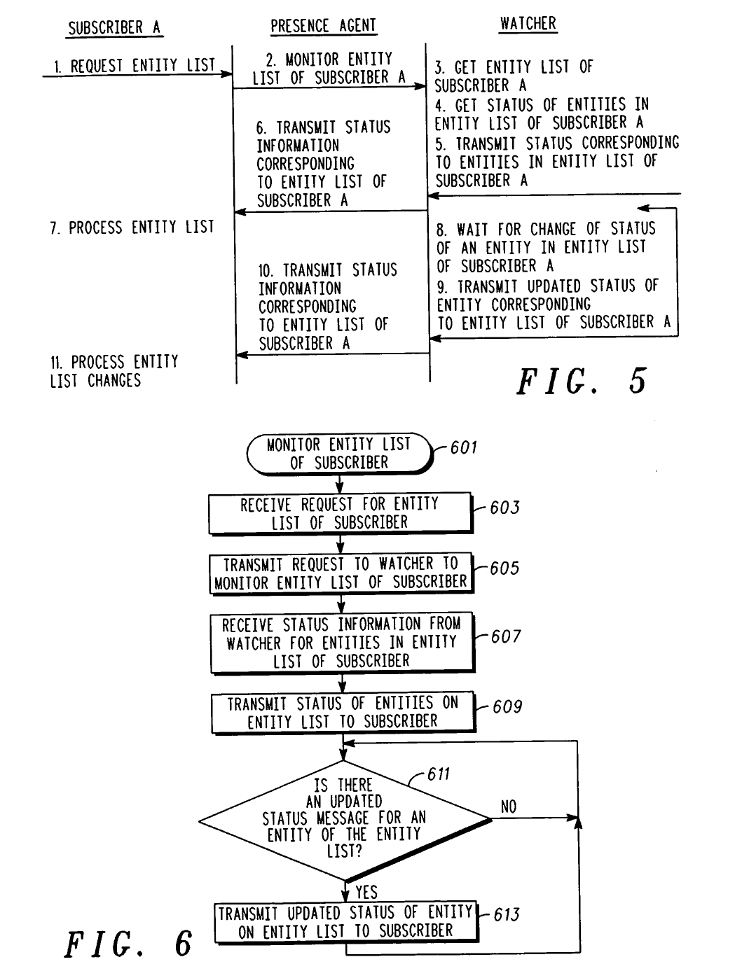

An example of a flow of communication for entity status in accordance with one or more embodiments will now be discussed and described. FIG. 5 is an exemplary flow or ladder diagram illustrating an exemplary communication flow in accordance with various embodiments. This example illustrates a simplified communication involving the communication device of subscriber A, a presence agent, and a watcher.

The communication device of subscriber A 1 transmits a request for monitoring an entity list to the presence agent. The request for monitoring an entity list, and transmission of the entity list, has been discussed in detail herein. The presence agent, upon receipt of the request for the entity list, transmits 2 a communication to monitor the entity list of subscriber A to the watcher.

Upon receipt of the foregoing communication from the presence agent, the watcher gets 3 the entity list corresponding to subscriber A. The entity list can be obtained from, e.g., content of the communication, or from a separate storage of entity lists corresponding to various subscribers. For example, the watcher can transmit an appropriate query to a database of entity lists such as the dispatch network database, e.g., “who is the ‘buddy list’ of subscriber A?;” the database may respond, e.g., “‘buddy list’=(John, Mary, Bob)”. The communication can further identify a particular entity list, thereby permitting the potential of multiple entity lists to be utilized by a subscriber.

Having obtained the list of entities in the entity list, the watcher can get 4 the status of the entities in the entity list of subscriber A. In one or more embodiments, the watcher obtains the status from an existing database that stores status, as explained previously. For example, the watcher can query an appropriate database, e.g., the VLR AND/OR HLR database, to obtain the status, e.g., “presence status (John, Mary, Bob)?”; and the database can reply, e.g., “John=off, Mary=on, Bob=busy”. According to alternative exemplary embodiments, the watcher can maintain a temporary database for entities being monitored, and can periodically query the existing database that stores status, in order to maintain status of entities within the temporary database.

With the status of the entities now obtained, the watcher can transmit 5 the status corresponding to the entities in the entity list of subscriber A to the presence agent. In this example, the status information includes presence status.

The watcher then proceeds to wait 8 for a change of status of an entity in the entity list of subscriber A. In accordance with one or more embodiments, this functionality of the watcher can be provided as part of an existing process for updating the existing database of entity status. In accordance with one or more alternative embodiments, the watcher can periodically obtain updates to entities which it is monitoring. Once a status of an entity has changed, the watcher can transmit 9 the updated status, e.g., the presence status, of the entity corresponding to the entity list of subscriber A. In accordance with various embodiments, a transmission of changed entity status can include the relevant changed entity status, or can include the current status for part or all of the entities in the entity list. Where the entity with the changed status corresponds to more than one entity list, one or more embodiments provide that the updated status for each entity list can be transmitted to the presence agent.

The presence agent, having received the status information from the watcher, can transmit 6 the status information, e.g., advantageously only status information which has changed, where the status information, e.g. presence information, corresponds to the entity list of subscriber A (or a portion thereof), to the communication device of subscriber A. Upon receipt of the status information, the communication device of subscriber A processes 7 the entity list. Processing of entity lists has been previously described.

Further, the presence agent can receive updated status information from the watcher. Upon receipt of updated status information from the watcher, the presence agent can transmit 10 the status information, e.g., presence information, corresponding to the entity list of subscriber A. Upon receipt of the updated status information, the communication device of subscriber A processes 11 the entity lists changes, as previously described herein.

As will be understood by one of skill, the watcher, presence agent, and/or subscriber A can provide a capability to modify an entity list, to delete an entity list, and to add an entity list. Moreover, the watcher and/or presence agent can terminate monitoring of an entity list, for example, in response to a specific request initiated by the subscriber, or responsive to, e.g., the requesting subscriber becoming “off”.

Although these examples have been provided in simplified form, it will be appreciated that a subscriber can monitor multiple entity lists, and the presence agent and watcher can be responsive to multiple subscribers. Moreover, it should be that various logical groupings of functions or resources described herein may be omitted from one or more embodiments, or that functions may be grouped differently, combined, augmented, or distributed to additional hardware. For example, databases described in connection with the watcher and/or presence agent can be distributed to additional hardware.

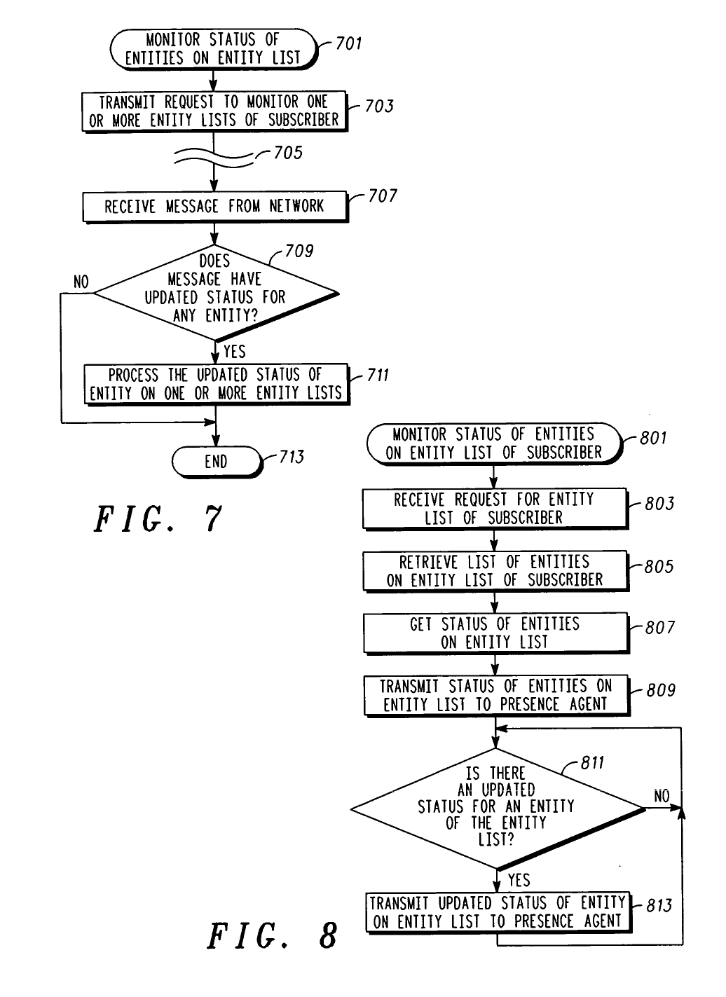

FIG. 6, FIG. 7, and FIG. 8 provide flow charts to illustrate in simplified form procedures that can be provided in connection with the presence agent, the communication device, and the watcher, respectively.

FIG. 6 is a flow chart illustrating an exemplary procedure for monitoring an entity list of a subscriber in accordance with various exemplary embodiments. The procedure can advantageously be implemented on, for example, a processor of a controller, described in connection with FIG. 2 or other apparatus appropriately arranged. In this example of monitoring the entity list of a subscriber 601, the process receives a request for the entity list of the subscriber 603, for example from a communication device for the subscriber. The request may, for example, omit the entity list where another process has information corresponding to the entity list. Alternatively, the request can specify the entities in the list, entities in a modified entity list, etc. Optionally, the process stores information on the entities in the entity list.

Having received a request for the entity list of the subscriber, the process proceeds to transmit 605 a request, for example, to the watcher, to monitor the particular entity list of the subscriber. Then, the process receives 607 status information from the watcher for the entities in the entity list corresponding to the subscriber. The process transmits 609 the status of the entities on the entity list to the communication device of the subscriber, as described previously.

The process then loops 611, 613 in order to check for updated status information and to transmit updated status information to the communication device of the subscriber. Hence, the process checks 611 whether there is an updated status for one or more entities on the entity list. If so, the process transmits 613 the updated status of the entity on the entity list to the communication device of the subscriber.

FIG. 7 is a flow chart illustrating an exemplary procedure for monitoring a status of entities on an entity list in accordance with various exemplary and alternative exemplary embodiments. The procedure can advantageously be implemented on, for example a communication unit, specifically a processor of a controller, as described in connection with FIG. 3 or other apparatus appropriately arranged.

In overview, the example procedure for monitoring a status of entities comprises a first connection 703, 705 typically initiated by the communication device, and a second connection 707, 709, 711, 713 initiated by the communication network.

Accordingly, the process for monitoring the status of entities on the entity list 701 provides for transmitting 703 the request to monitor one or more entity lists of the subscriber. Once the request has been transmitted, and optionally acknowledged by the communication network, the first communication can be terminated 705.

The process provides for a second connection initiated by the communication network, advantageously upon a change in a status of an entity in the subscriber's entity list. Accordingly, a message is received 707 by for example the communication unit from the network once the connection is initiated. The process provides for determining whether the message 709 has an updated status for an entity. If not, the message can be discarded or otherwise processed in accordance with its contents. Otherwise, the updated status 711 of the entity on one or more entity lists can be processed. A detailed description of the processing of status updates has previously been provided. Once the update has been processed, the connection and/or processing can be terminated 713, however the process of FIG. 7 may be repeated as needed.

FIG. 8 is a flow chart illustrating an exemplary procedure for monitoring a status of entities on the entity list of a particular subscriber, in accordance with various embodiments. The procedure can advantageously be implemented on, for example, an infrastructure device arranged for use as a watcher, specifically a processor of a controller, as described in connection with FIG. 4 or other apparatus appropriately arranged.

In accordance with the illustrated example, a procedure for monitoring the status of entities on an entity list of a particular subscriber 801 can include receiving a request 803 for the entity list of the subscriber. Upon receipt of the request, the procedure provides for retrieving 805 the list of entities on the entity list of the subscriber. The list of entities can be stored locally, or can be obtained from a separate device, as previously explained. If the procedure already has information concerning the entities that are included on a particular entity list, there is of course no need to retrieve the list of entities corresponding to the entity list.

Having the list of entities corresponding to the entity list of the subscriber, the process can then get 807 the status of the entities on the entity list. The status can be stored locally, or can be obtained from a separate device, as previously explained. The procedure then provides for transmitting 809 the status of the entities on the entity list to, e.g., the presence agent, as previously described.

The process then loops 811, 813 in order to check for an updated status for one or more of the entities in the entity list and to transmit updated status. Hence, the process checks 811 whether there is an updated status for one or more entities on the entity list. If so, the process transmits 813 the updated status of the entity on the entity list to, e.g., the presence agent, to be forwarded to the communication device of the subscriber. The process of FIG. 8 may be repeated as needed.

It should be noted that the term communication unit may be used interchangeably herein with subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network. Examples of such units include personal digital assistants, personal assignment pads, and personal computers equipped for wireless operation, a cellular handset or device, or equivalents thereof provided such units are arranged and constructed for operation in different networks.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore the wireless communication units or devices of interest may have short range wireless communications capability normally referred to as WLAN (wireless local area network) capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication units or devices of interest may be connected to a LAN using protocols such as TCP/IP, UDP/UP, IPX/SPX, or Net BIOS via a hardwired interface such as a cable and/or a connector.

Much of the inventive functionality and many of the inventive principles when implemented, are best supported with or in software or integrated circuits (ICs), such as a digital signal processor and software therefore or application specific ICs. Where appropriate, the processor can be, for example, a general purpose computer, can be a specially programmed special purpose computer, can include a distributed computer system, and/or can include embedded systems. Similarly, where appropriate, the processing could be controlled by software instructions on one or more computer systems or processors, or could be partially or wholly implemented in hardware. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A server comprising:
a first communication interface, for transmitting and receiving communications when operably connected to a first communication network; and
a processor cooperatively operating with the first communication interface and configured to facilitate: receiving at least one first message having a request for a status of at least one entity; determining the status of the at least one entity; and transmitting, responsive to the determining, at least one second message having the status of the at least one entity, wherein the transmitting further includes initiating a connection to a communication device intended to receive the at least one second message.

2. The server of claim 1, further comprising a second communication interface, for transmitting and receiving communications when operably connected to a second communication network; wherein the determining includes receiving at least one third message with the status of the at least one entity in accordance with the second communication interface.

3. The server of claim 2, wherein the determining further includes transmitting a request for the status of the at least one entity in accordance with the second communication interface.

4. The server of claim 1, wherein the at least one first message further indicates a request to monitor the status.

5. The server of claim 1, wherein the at least one second message is transmitted in accordance with a short message system (SMS) protocol to a communication device.

6. The server of claim 1, wherein the at least one first message includes an indication of a plurality of entities including the at least one entity, and a user identifier corresponding thereto.

7. The server of claim 6, wherein the processor is further configured to change the entities in the plurality of entities, responsive to a third message received in accordance with the first communication interface indicating a change of entities in the plurality of entities.

8. The server of claim 1, wherein the processor is further configured to transmit, in accordance with the first communication interface, a third message indicating a change in the status, responsive to a determination that the status of the at least one entity has changed.

9. The server of claim 8, further comprising a second communication interface, for transmitting and receiving communications when operably connected to a second communication network; wherein the determination is responsive to receipt of a fourth message received in accordance with the second communication interface indicating a change in the status of the at least one entity.

10. The server of claim 1, wherein the status indicates a presence of the entity in relation to the first communication network.

11. A communication unit, comprising:
a transceiver for receiving signals when operably connected to a communication network; and
a processor cooperatively operable with the transceiver and configured to facilitate: transmitting at least one first message having a request for a status of at least one entity; receiving from a connection initiated by the communication network, at least one second message having a status of the at least one entity; and processing, responsive to the at least one second message, the status of the at least one entity.

12. The communication unit of claim 11, wherein the connection is in accordance with a short message system (SMS) protocol.

13. The communication unit of claim 11, wherein the processing includes updating a display indicating the status of the at least one entity.

14. The communication unit of claim 11, wherein the processor is further configured to facilitate determining at least one plurality of entities including the at least one entity.

15. The communication unit of claim 14, wherein the processor is further configured to facilitate transmitting the at least one plurality of entities in accordance with the transceiver.

16. The communication unit of claim 15, wherein the at least one plurality is transmitted responsive to a change of entities in the at least one plurality.

17. The communication unit of claim 1 1, wherein the status indicates a presence of the entity in relation to the communication network.

18. A server, comprising:
a communication interface for receiving communications when operably connected to a communication network;
a processor cooperatively operable with the communication interface and configured to facilitate: receiving at least one request, indicating a user identifier, for a status of at least one entity; first determining at least one entity indicated by the user identifier; second determining the status of the at least one entity; and transmitting, responsive to receipt of the at least one request, a response indicating the status of the at least one entity.

19. The server of claim 18, wherein the processor is further configured to facilitate detecting a change of the status; and transmitting, responsive to the change, a message indicating the at least one entity and the corresponding status, in accordance with the communication interface.

20. The server of claim 19, wherein the request further indicates a list identifier; wherein the processor is further configured to facilitate retrieving a list of a plurality of entities including the at least one entity, the list corresponding to the user identifier and the list identifier; and determining the plurality of entities on the list.
